(19) United States
(12) Patent Application Publication
(10) Pub. No.: US 2002/0069182 A1
(43) Pub. Date: Jun. 6, 2002

(54) System and method for alternative dispute resolution

(76) Inventor: Stephen C. Dwyer, Potomac, MD (US)

Correspondence Address: Roberts Abokhair & Mardula, L.L.C., Suite 1000, 11800 Sunrise Valley Drive, Reston, VA, 20191-5302, US

(21) Appl. No.: 09/730,632

(22) Filed: Dec. 6, 2000

Related U.S. Application Data
(60) Provisional application No. 60/169,094, filed on Dec. 6, 1999.

(51) Int. Cl. G06F 17/60

(52) U.S. Cl. 705/80

(57) ABSTRACT

The present invention provides a system and method for alternative dispute resolution involving multiple offers and flexible setting of settlement parameters. Individuals determine whether settlement offers overlap with one another without deciding the settlement terms. Terms may be monetary, non-monetary, or time-limited. Participants access the system on a web site. Participants submit a series of confidential settlement demands beginning with non-monetary demands. Unique identifying devices match respective settlement demands against one another. When a participant signs on to the web site, a “click-wrap” agreement binds him to the terms of any settlement reached. Participants pay a fee for each round of negotiations. Where settlement figures overlap, an algorithm resident on the server of the present invention chooses the midpoint between the figures. Participants may restrict the analysis to knowing whether their demands overlap. If a settlement is reached, email messages are sent to the parties.

### FIELD OF THE INVENTION

This invention relates generally to alternative dispute resolution. More particularly, the present invention is a system and method for alternative dispute resolution involving multiple offers and flexible setting of settlement parameters.

### BACKGROUND OF THE INVENTION

Alternative dispute resolution (ADR) has long been a useful, cost-effective tool in settling disputes between parties. For example, litigation before the courts of the United States can be very expensive and time consuming. Alternatively, ADR offers the opportunity for individuals and organizations to get together either through mediation, where the mediator generally recommends settlement solutions without any authority to impose such a solution, and binding arbitration wherein an arbitrator hears evidence, much like a judge, and decides on a particular solution for the individuals. These procedures usually take place in a streamlined fashion, without the normal legal give and take that accompanies a full litigation.

U.S. Pat. No. 5,495,412 describes a system for settling disputes over a network. This system is designed to equalize settlement contributions between the parties. Each party rates the importance of each term in a settlement offer. The settlement is optimized to the best possible outcome for both parties according to the ratings assigned.

U.S. Pat. No. 5,983,205 also describes a settlement system where the parties rate terms by assigning point values. A settlement requires the parties to have equal point values. This system is particularized to divorce settlements where each piece of personal property is a term of the dispute.

U.S. Pat. Nos. 5,895,450 and 5,668,953 describe a system which settles customer complaints. A customer writes a description of the problem he or she is having. Analysis is conducted by identifying key words in both the description and information on file for the customer. The decision algorithm proposes settlement terms supplied from both independent sources and the parties. Parties may reject the settlement and are not bound in any way to the proposed settlement.

U.S. Pat. No. 5,956,687 to Wamsley, et al., describes a computerized system for managing a personal injury claim. This system manages information gathering and administrative aspects of litigating the claim. Negotiations are done directly between the parties, with no automated negotiating described.

U.S. Pat. Nos. 5,950,169; 5,930,759; 5,253,164; 5,991,733; and 5,692,206 describe computerized systems for managing or submitting insurance claims and do not provide automated negotiation. The system described in U.S. Patent 5,749,785 offers and settles bets having a true or false answer. In more recent times, various Internet websites have come into existence to analyze litigants, and potential litigant's settlement demands to enable the parties to attempt to settle their claims online. Two such examples are available at www.cybersettle.com and www.clicknsettle.com. These Internet solutions, while useful, have tended to be ones where the litigants can make an offer and, if they are within a given range the case can be settled. Otherwise, there is no additional give and take. Both of the above mentioned sites allow parties to enter confidential settlement monetary figures into the website. If the settlement figures are within thirty percent of one another, a settlement figure is reached which constitutes the midway point between two proposed settlements.

However, it is frequently the case that a settlement offer may turn on the amount of time over which the settlement is to be paid, when payments are to begin, what other types of services or business deals may be offered, and many other factors.

What would truly be useful is a system that allows for time periods of various types to be an integral part of the settlement offer, provides additional information regarding the overlap of settlement offers from the various parties, allows for the entry of other than monetary claims, and provides other incentives to the parties so that only those who are truly willing to enter into settlement agreements are clients of the system.

### SUMMARY OF THE INVENTION

It is therefore an objective of the present invention to prevent or truncate litigation.

It is a further objective of the present invention to provide a means for analyzing the potential settlement while litigation is ongoing.

It is a further objective of the present invention to reduce legal fees by enabling settlement in an alternative fashion.

It is yet another objective of the present invention to clarify the parties' goals in attempting to settle a case.

It is yet another objective of the present invention to save the parties' time and money by preventing prolonged negotiation.

It is yet another objective of the present invention to conserve judicial resources by reducing the number of cases pending in the court system.

It is a further objective of the present invention to provide for online settlement of disputes.

It is a further objective of the present invention to allow individuals to determine whether settlement offers overlap with one another without deciding the settlement terms.

It is yet another objective of the present invention to allow for the parties to input other than monetary terms as a settlement to any dispute.

It is a further objective of the present invention to allow the parties' to input time as an element of any settlement agreement.

The present invention functions by initially providing, via a website access by the participants, information on how the settlement process works. For a fee, each party can submit a confidential settlement demand/offer into the system. Each party will be assigned a password or other unique identifying device/authorization code so that the present invention can match respective settlement demands against one another. For example, the participants may have a common code relating to their dispute, but different codes that relate to the identification of each of the parties.

When an individual signs on to the website of the present invention, the settlement process is explained, and the individual electronically signs a “click-wrap” agreement, which binds him to the terms and conditions of any settlement, if in fact a settlement is reached. As noted above, the parties are charged a fee for using the site. Each party can pay part of the fee, or the fee can be paid in full by one of the parties.

A claimant, that is, a party feeling that it is entitled to monetary relief, submits a number of monetary settlement amounts corresponding to payment time frames. These settlement amounts represent the least amount for which the party would be willing to settle the case. Payment time frames are shown for the settlement amounts.

An important aspect of the present invention is that any such offer is a claimant's best and final offer. Thus, there is no negotiation of the various claim amounts. In short, the system is designed to be used by those who truly want to settle disputes, although this is not meant as a limitation. The system of the present invention can be adapted to have multiple rounds of offers and negotiations between the claimant and the respondent. The system works as follows:

A claimant registers with the system of the present invention and submits its non-monetary claims, if any. The respondent views the non-monetary claims and enters its (the respondent's) non-monetary claims, if any, and also submits its monetary claims. these monetary claims also have a timeframe for payment and represent the most that the respondent is willing to settle for.

The claimant then views the respondent's non-monetary claims, if any, and enters its (the claimant's own) monetary claims. In the event that there are no non-monetary claims, the claimant will still submit its own monetary claims.

If a party does not accept another party's non-monetary demands, the party does not submit its own monetary claims. This situation would terminate the negotiation process. The parties would not then be charged for this limited interaction. In the business model of the present invention, the parties are only charged if a comparison of the monetary demands is made.

In addition to the monetary claims, and as noted above, claimant's can also submit non-monetary claims by typing them into a free text block on the website. Thus, for example, if a claimant desires a public apology, the claimant may submit this demand on the site.

The various monetary claims will be confidential. If however, a free text non-monetary claim is made, such a claim will not be confidential, and will be shown to the adversary as an essential part of the demand by the claimant. In a similar fashion, the adversary also submits the adversary's bottom-line confidential settlement figures, and non-monetary claims, which are not confidential. If the figures overlap with those submitted by the claimant, an algorithm resident on the server of the present invention will choose the midpoint between the settlement figures.

The present invention will also impose a restriction on the parties to the dispute. If the parties for example, simply wish to know that their settlement demands overlap, they can have that information. If however, the parties agree that they wish to have the specific settlement figure arrived at by the algorithm in the present invention to be disclosed to them, then the final settlement number will be binding upon them.

Upon submission of the various settlement offers as noted above, and upon both parties assent to the terms of the settlement action of the present invention, then computer analysis will take place immediately, and an appropriate email message will be sent to the parties.

### BRIEF DESCRIPTION OF THE DRAWINGS

FIG. 1 illustrates the overall architecture of the present invention.

FIGS. 2A and 2B illustrate a flowchart according to an embodiment of the present invention.

### DETAILED DESCRIPTION OF THE INVENTION

As noted above, the present invention is a system and method for alternative dispute resolutions over a network, preferably the Internet. However, this is not meant as a limitation. For example, local area networks (LANs) or wireless networks are capable of providing a means of communication among disputing parties.

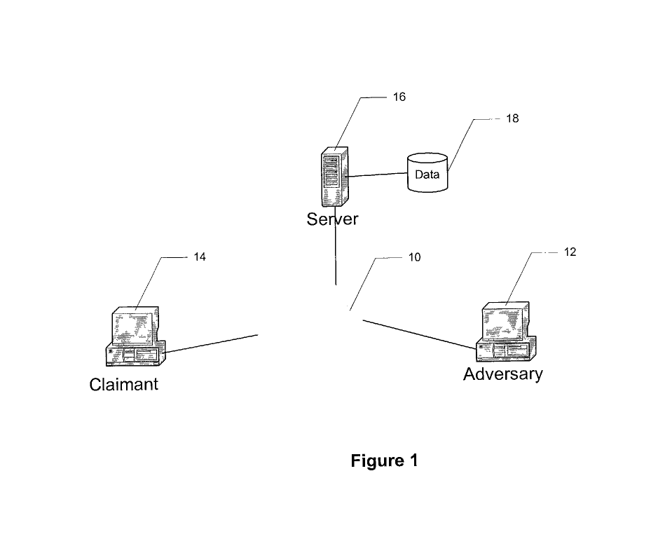

Referring to FIG. 1, the overall architecture of the present invention is illustrated. A claimant computer 14 and an adversary computer 12 are connected to a network, preferably the Internet 10. Both the claimant computer 14 and the adversary computer 12 can be implemented with any personal computer having memory, a processor, input and output hardware and software, and hardware and software capable of providing Internet access.

A server of the present invention 16 is also connected to the Internet and comprises a server which may be an IBM compatible, a Sun server, or indeed any server capable of receiving communications and processing data contained in those communications. Server 16 also comprises a database 18 from which the settlement algorithm of the present invention is drawn when needed. In addition, database 18 stores the various offers made by the adversarial parties. Adversary computer 12 is also connected to the Internet and provides the various communications to the server 16 of the present invention.

The server 16 contains documents formatted as web pages of hypertext documents. The web pages are viewed with a web compliant browser, such as the Netscape Navigator browser. Each hypertext document or web page may contain references to graphic files or banners that are to be displayed in conjunction with the hypertext document or web page. Web pages are used to gather information needed to resolve the dispute. Such information includes, but is not limited to, party names, payment information, settlement offers, and passwords. Information is stored in the database 18.

The server 16 additionally stores and executes payment software. The claimant and/or opponent must pay for the service of having their settlement negotiated. Methods of conducting transactions over the Internet are well known. Any known method of conducting Internet commerce may be used in the system of the present invention. Wallet services, credit card transactions, or tokens are but a few examples of current methods of conducting Internet commerce.

As noted above, when both the claimant and the adversary agree that the settlement process of the present invention is to be invoked, the claimant computer 14 and the adversary computer 12 are registered with the server 16. Server 16 then provides unique identification numbers or codes to the adversarial parties. In this fashion, the server can match corresponding settlement offers from the claimant computer 14 and the adversary computer 12, and operate on those settlement offers using the algorithms stored in database 18.

In order to enhance security, encryption algorithms are optionally distributed by server 16 to the adversarial parties 12 and 14. In this fashion, all communication to the server can be encrypted to prevent any unauthorized access to any settlement offers.

In addition to settlement amounts, and, as noted above, time frames for payment of the settlement amount are specified by the site. Additionally, non-monetary terms may be submitted and stored for subsequent distribution to the adversarial parties. Once the analysis of the individual offers is completed, an email message is forwarded to the parties in either encrypted, or non-encrypted form advising them to log onto the site to review the results. The results could be that the settlement offers overlap, that no settlement can be arrived at, or that a settlement number has been calculated by the algorithm of the present invention.

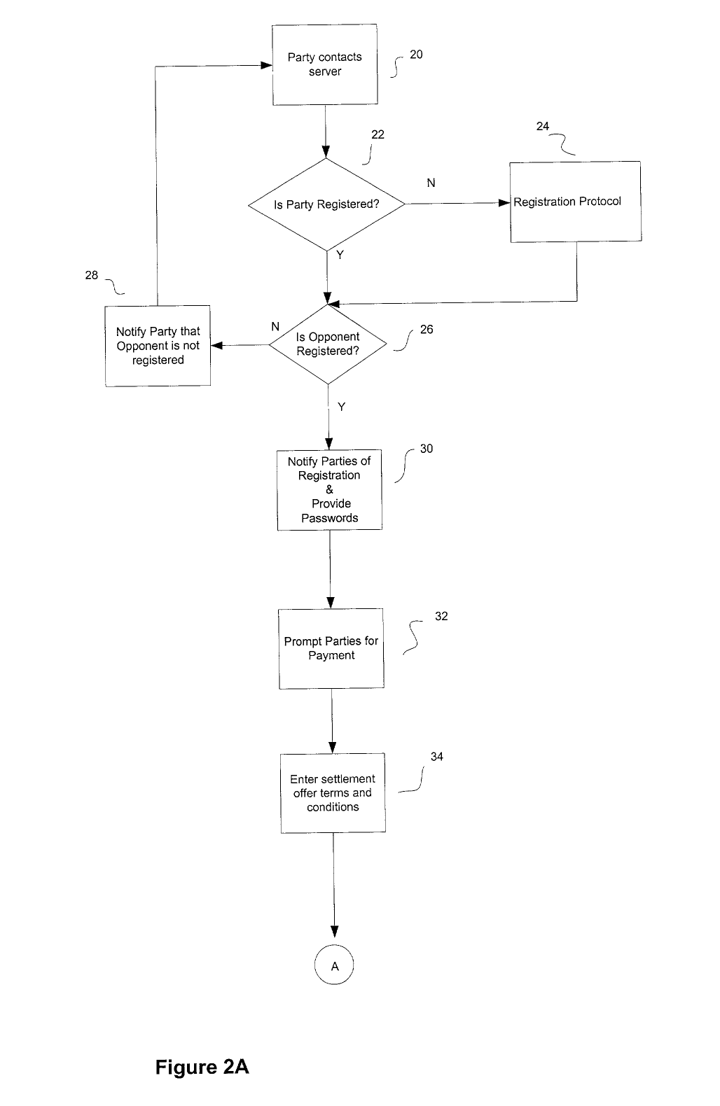

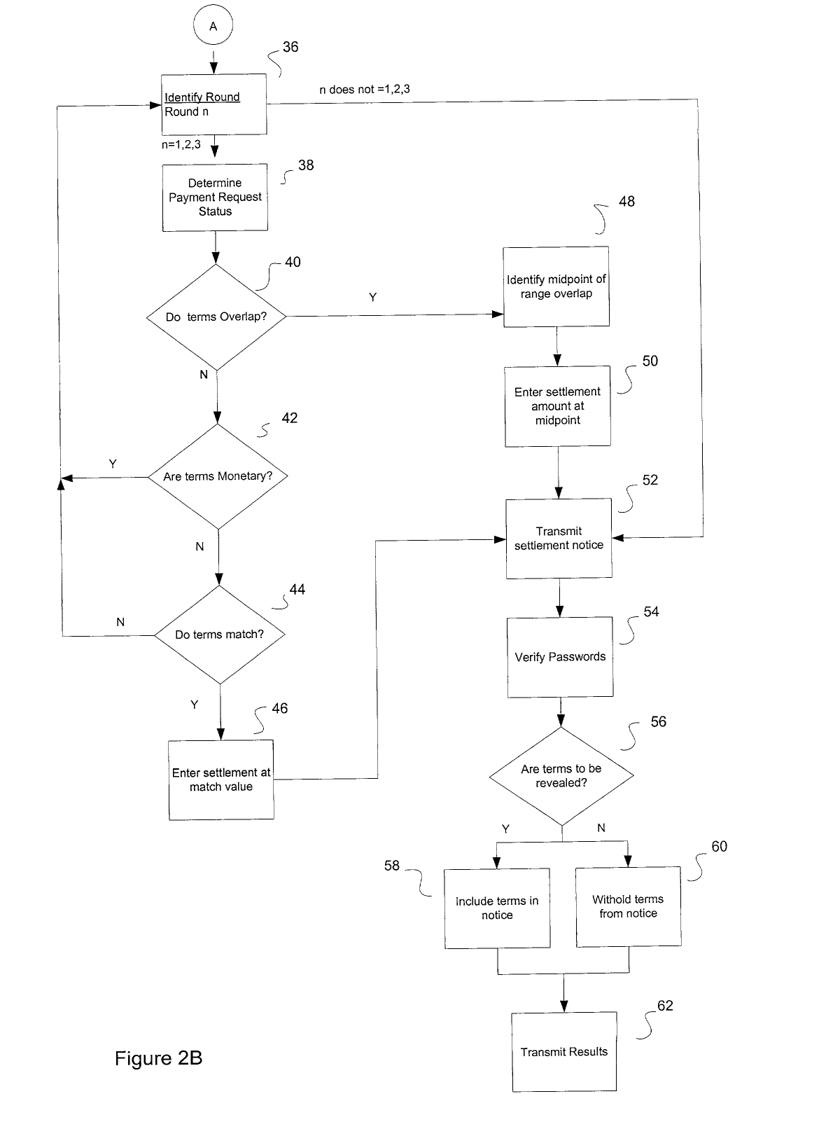

Referring to FIGS. 2A and 2B, a flowchart of an embodiment of the present invention is illustrated. To initiate the settlement process, a party to the suit or negotiation, contacts the settlement server 20. The party is prompted to enter registration information 22. If the party has not registered, a registration protocol is launched 24 by the settlement server 16 (not shown). With registration protocol, the party is asked to enter his name, email contact, and the opposing party's name. An e-mail is then sent to the opposing party inviting it to settle the dispute through the web site. Both parties must agree to be bound to the settlement during the registration process. The server transmits a web page to each party having the terms and conditions making the settlement binding. A “click-out” button is provided on the page. The act of clicking the button activates an imbedded response which is transmitted to the server. The server stores each party's response in the database.

After each party has registered, the settlement algorithm verifies whether the named opposing party has registered 26. However, where the opponent has registered, the settlement algorithm proceeds.

Once both parties are registered, the settlement algorithm proceeds. An email message is sent to both the claimant and the opponent notifying them of complete registration, and providing unique passwords needed to access and further provide settlement information 30. Next, both the claimant and the opponent are prompted to pay a fee in order to start settlement negotiations 32. One or both parties may pay the required fee. The initial fee only entitles the parties to one round of making a settlement offer, corresponding to the relevant timeframe for payment and evaluation. As further explained below, payment is required before each round of negotiations. Thus, the parties have incentive to settle with a minimum of negotiations and begin the settlement process with their best and final offers.

Once the server processes payment, the parties are next prompted to enter their settlement offers and associated conditions 34. The server transmits a web page to both parties with blocks for entering settlement terms in multiple rounds. Settlement offers can be monetary, non-monetary, or both. For example, the claimant may be willing to settle for a minimum of $2,000.00 while the adversary is willing to settle for a maximum $4,000.00. A non-monetary settlement offer could be a public apology or requiring community service. An example of a mixed settlement offer might be that the claimant demands $2,000.00 if the payment is to be made within thirty days, $3,000.00 if the payment is to be made between 30 and 60 days, $4,000.00 if the payment is to be made between 60 and 90 days, and so on.

The parties also enter conditions for the settlement process. One term of the settlement process that the parties specify is whether they want the arrived upon settlement figure revealed.

Once the parties have entered their offers and terms, the server executes a settlement analysis algorithm. First, the current round of negotiations is identified 36. A default is set at three rounds of negotiations. This default condition is shown in FIG. 2B. However, the parties may increase or decrease the number of rounds they desire in negotiation. Based on the number of rounds selected, the algorithm next identifies whether the parties should be prompted for further payment 38. If negotiations are in round 1, payment for round 1 has already have been entered by the system 34. As a result, the algorithm proceeds to the next analysis step 40. Where the final round has not yet been reached, the system prompts the parties to pay for the next round of negotiations before proceeding with settlement analysis. Where the final round has finished, the system notifies the parties that settlement analysis is completed 52. This notification process and subsequent steps executed by the system are further described below.

Once the algorithm identifies a payment amount has been entered for the round 36, the terms of settlement are evaluated. Terms are evaluated on a round basis, which means the terms of the settlement offer entered in round 1 by the claimant are compared to the terms of the settlement offer entered in round 1 by the opponent. First, the system compares the terms for overlapping values 40. Where an overlap is not identified, the condition exists either because there is no overlap of numerical terms. If the terms do overlap, the midpoint of the over lapping ranges is identified 48. Then, the settlement is entered at the midpoint amount 50. An example would be where the claimant will accept a settlement of over $2,000 and the opponent will settle for up to $5,000, the midpoint of the overlap range would be $3,500.

If the terms are monetary, but no overlap is detected 42, the algorithm steps to the next round 36. It should be noted that the non-monetary terms of each party are shown to the other. If a party cannot agree to the non-monetary terms of the other party, the non-agreeing party will refrain from submitting its monetary claims to the present invention for evaluation. The parties will be charged a fee if, and only if, the comparison algorithm of the present invention is used to compare the monetary demands of the party, one to another.

Whether all the rounds have progressed without a settlement being reached 36 or a settlement has been reached 46, 50, the parties are notified of the results. An email message is sent to both parties notifying them that a result settlement has been reached 52. Both parties log on to the server with their passwords. The system verifies the passwords are associated with each party 54. Then, the system further verifies whether the terms of the settlement should be revealed to the parties 56. If the parties requested the terms to be revealed, the terms are included in a notice of the results 58. If the parties did not want the terms revealed, only whether settlement was reached or the final settlement will be included in the notice 60.

There is no special purpose equipment required for the present invention. For example:

The Web Server comprises:

Dell 6450 w/4 Intel 700 MHz Xeon Processors

36 GB Ultra 3 SCSI Hard disk

4 GB SDRAM

2 Intel Pro 1000 Gigabit Network Interface Cards

Another type of server that will suffice for the present invention is:

Dell 2450 w/1 Intel 733 Mhz Pentium III (additional processor may be added in the future)

36 GB SCSI Hard Disk

1 GB SDRAM

1 Intel Pro 1000 Gigabit Network Interface Card

These servers are illustrative of the type of server that will find utility with the present invention. Other servers from, for example IBM, Sun Microsystems and Compaq will also be useful with the present invention so long as they have the same or similar capabilities.

Similarly, there are no special requirements for the workstations that access the system over the Internet. PC or PC compatible workstations running Windows, Windows NT, Windows 2000, having a web browser such as Netscape or Microsoft Explorer, having an Intel, AMD or other processor with associated RAM and storage will all be useful for the present invention.

A system and method for alternative dispute resolution over a network has been shown. It will be apparent to those skilled in the art that other types of settlement parameters may be presented and negotiated or calculated via an algorithmic approach without departing from the scope of the invention as disclosed.

We claim:

1. A system for settling disputes between a plurality of parties through a network comprising:
at least one claimant computer associated with a claimant connected to the network;
at least one respondent computer associated with a respondent connected to the network; and
a settlement computer connected to the network, wherein;
the settlement computer further comprising a processor and memory, wherein the memory stores instructions for enabling the processor to:
receive a request for a settlement from the claimant computer or the respondent computer;
provide an agreement binding the claimant and the opponent to the settlement;
accept monetary and non-monetary offers of settlement from the claimant computer and from the opponent computer;
require payment before comparing the offers of settlement;
compare the offers of settlement for an overlapping value;
settle an overlapping value at a midpoint between said offers of settlement; and
repeat the requiring payment and said comparing instructions when no overlapping value or said matching value is detected.

2. The system of claim 1 wherein the offers of settlement further comprise a time frame as a condition of settlement.

3. The system of claim 1 wherein the offers of settlement further comprise a non-monetary term as a condition of settlement.

4. The system of claim 1 wherein the memory of the settlement computer further stores instructions that enable the processor to provide an option to reveal arrived-at settlement terms at the claimant computer and the opponent computer.

5. The system of claim 1 wherein the memory of the settlement computer further stores instructions that enable the processor to provide a unique identification code to each of the plurality of parties.

6. The system of claim 1 wherein the memory of the settlement computer further stores instructions that enable the processor to provide an automatic notification to each of said plurality of parties when a settlement has been reached.

7. The system of claim 6 wherein the automatic notification is an email message.

8. The system of claim 1 wherein the memory of the settlement computer further stores instructions that enable the processor to display settlement results at a web site.

9. A method of forming a settlement agreement between a plurality of parties over a network comprising the steps of:
receiving a request for a settlement from parties to a dispute;
binding the parties to the terms of a settlement reached;
accepting a settlement offers from the parties;
requiring payment before analyzing the settlement offers;
comparing said offers of settlement for an overlapping value; and
settling the dispute at a midpoint between overlapping values of the settlement offers.

10. The method of claim 9 further comprising the step of repeating the step of requiring payment and the step of comparing offers of settlement when no said overlapping value is detected.

11. The method of claim 9 further comprising the step of allowing the parties to view non-monetary aspects of the series of offers.

12. The method of claim 9 further comprising the step of providing a unique identification code to each of the plurality of parties.

13. The method of claim 9 further comprising the step of automatically notifying the claimant and the opponent when a settlement has been reached.

14. A network dispute resolution system comprising:
a claimant computer associated with a claimant;
an opponent computer associated with an opponent; and
a settlement computer having a processor and memory;
wherein the claimant computer, opponent computer and settlement computer are connected through the network; and
wherein the memory of the settlement computer stores software instructions which enable the processor to perform the function comprising providing an agreement binding said claimant and said opponent to one or more settlement terms.

15. The system of claim 14 wherein the memory of the settlement computer further stores software instructions which enable the processor to perform the functions comprising:
receiving a request for a settlement from the claimant computer or the opponent computer;
accepting offers of settlement from the claimant computer and from the opponent computer;
requiring payment before comparing the offers of settlement;
comparing the offers of settlement for an overlapping value;
settling an overlapping value at a midpoint between said offers of settlement; and
repeating the requiring payment and said comparing instructions when no overlapping value or said matching value is detected.

16. The system of claim 15 wherein the memory of the settlement computer further stores instructions that enable the processor to perform the function comprising providing an option to reveal arrived at settlement figures at the claimant computer and the opponent computer.

17. The system of claim 15 wherein the memory of the settlement computer further stores instructions that enable the processor to perform the function comprising providing a unique identification code to each of the plurality of parties.

18. The system of claim 15 wherein the memory of the settlement computer further stores instructions that enable the processor to perform the function comprising providing an automatic notification to each of said plurality of parties when a settlement has been reached.

19. The system of claim 18 wherein the memory of the settlement computer further stores instructions that enable the processor to perform the function comprising providing an automatic notification with an email message to sign onto the site to review results to each of said plurality of parties when a settlement has been reached.

20. The system of claim 15 wherein the memory of the settlement computer further stores instructions that enable the processor to perform the function comprising displaying settlement results at a web site.

21. A network dispute resolution system comprising:
a claimant computer associated with a claimant;
an opponent computer associated with an opponent; and
a settlement computer having a processor and memory;
wherein the claimant computer, opponent computer and settlement computer are connected through the network; and
wherein the memory of the settlement computer stores software instructions which enable the processor to perform the functions comprising:
accepting a series of offers from the claimant and the opponent;
analyzing a first set of offers for settlement criteria; and
when no settlement criteria is detected in the first set of offers, requesting payment before analyzing a second set offers.

22. The system of claim 21 wherein the memory of the settlement computer further stores software instructions which enable the processor to perform the functions comprising:
comparing the offers of settlement for an overlapping value;
settling an overlapping value at a midpoint between said offers of settlement; and
repeating the requiring payment and said comparing instructions when no overlapping value or said matching value is detected.

23. The system of claim 22 wherein the memory of the settlement computer further stores software instructions which enable the processor to perform the function providing a unique identification code to the claimant and the opponent.

24. The system of claim 22 wherein the memory of the settlement computer further stores software instructions which enable the processor to perform the function comprising providing automatic notification to the claimant and the opponent when the settlement analysis algorithm has been conducted .

25. The system of claim 24 wherein the automatic notification is an email message.

26. The system of claim 22 wherein the memory of the settlement computer further stores instructions that enable the processor to display settlement results at a web site.

27. A method of settling disputes between parties over a network comprising the steps of:
accepting a series of offers of settlement from a claimant and an opponent;
evaluating a settlement based on an overlapping value between said offers of settlement.

28. The method of claim 27 further comprising the steps of:
binding the parties to the terms of a settlement reached;

29. The method of claim 27 further comprising the steps of:
requiring payment before analyzing each round of settlement offers;

30. The method of claim 27 further comprising the step of:
repeating the step of requiring payment and the step of comparing offers of settlement when no said overlapping value is detected.

31. The method of claim 27 further comprising the step of providing a unique identification code to each of the plurality of parties.

32. The method of claim 27 further comprising the step of automatically notifying the claimant and the opponent when a settlement has been reached.

33. The method of claim 32 wherein the automatic notification is an email message.

34. The method of claim 27 further comprising the step of displaying settlement results at a web site.

35. A system for settling disputes between a plurality of parties over a network comprising:
at least one claimant computer associated with a claimant;
at least one opponent computer associated with an opponent; and
a settlement computer having a processor and memory, and connected over a network wherein the memory stores software instructions for enabling the processor to:
accept a best and final settlement offer from the parties, being the claimant and opponent; and
evaluate an overlapping settlement offer or a matching settlement offer which includes a time frame for acceptance as a condition upon the offer.

36. The system of claim 51 wherein the memory further stores instructions for enabling the processor to bind the parties to the terms of a settlement reached.

37. The system of claim 35 wherein the memory further stores instructions for enabling the processor to require payment before analyzing the best and final settlement offers.

38. The system of claim 35 wherein the memory further stores instructions for enabling the processor to:
receive a request for a settlement from parties to a dispute;
bind the parties to the terms of a settlement reached;
accept a best and final settlement offer from the parties;
require payment before analyzing the best and final round of settlement offers;
compare said offers of settlement for an overlapping value; and
settle the dispute at a midpoint between overlapping values of the settlement offers.

39. The system of claim 35 wherein the memory further stores instructions for enabling the processor to provide a unique identification code to each of the plurality of parties.

40. The system of claim 32 wherein the memory further stores instructions for enabling the processor to provide an automatic notification to each of the plurality of parties when a settlement has been reached.

41. The system of claim 32 wherein the memory further stores instructions for enabling the processor to display settlement results at a web site.

42. A method of resolving a dispute over a network comprising the steps of:
receiving a request for settlement from parties to a dispute; and
binding the parties to one or more settlement terms.

43. A method of resolving a dispute over a network comprising:
accepting a series of monetary settlement offers from parties to a dispute; and
accepting timeframes over which the monetary settlement offers must be accepted. requiring payment before analyzing each of the series of offers.

44. A method of resolving a dispute over a network comprising:
accepting a best and final offers from the parties to the dispute; and
evaluating either an overlapping settlement offer, or a matching settlement offer which includes a time frame for acceptance as a condition upon the offer.

45. A system for settling disputes between a plurality of parties over a network comprising:
at least one claimant computer associated with a claimant;
at least one opponent computer associated with an opponent; and
a settlement computer having a processor and memory, and connected over a network wherein the memory stores software instructions for enabling the processor to:
accept a series of offers of settlement from a claimant and an opponent; and
evaluate a settlement based on an overlapping value between said offers of settlement.
